(19) United States
(12) Patent Application Publication
(10) Pub. No.: US 2011/0234346 A1
(43) Pub. Date: Sep. 29, 2011

(54) BONDED RARE EARTH MAGNET

(76) Inventors: Yoshinobu Honkura, Aichi (JP); Hiroshi Matsuoka, Aichi (JP); Kenji Noguchi, Aichi (JP); Norikazu Naitoh, Aichi (JP)

(21) Appl. No.: 12/998,847

(22) PCT Filed: Dec. 9, 2009
(86) PCT No.: PCT/JP2009/006719

§ 371 Date: Jun. 8, 2011

(30) Foreign Application Priority Data
Dec. 12, 2008 (JP) 2008-316767

(51) Int. Cl. H01F 7/02

(52) U.S. Cl. 335/302

(57) ABSTRACT

A bonded rare earth magnet which exhibits excellent magnetic properties for a long time is provided by improving oxidation resistance at high temperatures. The magnet has a magnet body (10) comprising magnet powder (11) containing a rare earth element and a resin part (12) binding the magnet powder (11) and having a structure in which the magnet powder (11) is embedded in the resin part (12); and an amorphous carbon film (91) formed directly on a surface of the magnet body (10), the resin part (12) comprising a binder resin part (14) binding the magnet powder (11); and a resin layer (13) serving as a surface layer of the magnet body (10) and covering the magnet powder (11). The binder resin part and the resin layer are formed of the same resin material and are continuous and integral with each other.

### TECHNICAL FIELD

The present invention relates to a bonded rare earth magnet having a coating film on a surface thereof.

### BACKGROUND ART

Owing to their excellent magnetic properties, rare earth magnets are used in a wide variety of fields. Especially, bonded rare earth magnets produced by using a mixture (a compound material) of magnet powder and a binder resin and connecting the magnet powder together by the binder resin are characterized not only by excellent magnetic properties but also by high degree of freedom in shape and high dimensional accuracy. Therefore, bonded rare earth magnets are used widely, especially in motors for automotive parts, and compact motors for household electrical appliance. In response to a demand for miniaturization of motors for automotive parts, compact motors which use bonded rare earth magnets, especially anisotropic bonded rare earth magnets, have been recently employed. With an increasing use of these bonded magnets, bonded rare earth magnets usable even at elevated temperatures above 150 deg. C. have been requested lately.

Typical examples of bonded rare earth magnets are bonded Nd—Fe—B based magnets and bonded Sm—Fe—N based magnets, but these magnets are susceptible to oxidation due to containing rare earth elements. Especially when these magnets are used at elevated temperatures, oxidation is promoted, which causes a deterioration of magnetic properties such as a decrease in magnetic force. Moreover, when used in a liquid, sometimes these magnets are oxidized by water and at the same time the liquid penetrates into these magnets and causes resin expansion, and as a result, magnetic properties degrade and shape retention becomes difficult. In order to exhibit excellent magnetic properties and shape retention for a long time, it has been done to protect surfaces of bonded rare earth magnets with various kinds of coating films.

For example, resin coating is applied on surfaces of bonded rare earth magnets by spray coating, electrodeposition coating and so on. In PTL 1, a metallic coating film is formed on a surface of a bonded rare earth magnet and then an amorphous carbon film is further formed on the metallic coating film. Although not regarding a bonded magnet, PTL 2 discloses formation of an amorphous carbon film on a surface of a sintered rare earth magnet. Since the amorphous carbon film is stable under high-temperature environments and excellent not only in mechanical properties but also in corrosion resistance, chemical resistance and oxygen barrier properties, the amorphous carbon film is suitable as a protective film.

### CITATION LIST

### Patent Literature

[PTL 1] Japanese Unexamined Patent Publication No. 2005-32845
[PTL 2] Japanese Unexamined Patent Publication No. 2005-268340

### SUMMARY OF INVENTION

### Problems to be Solved by the Invention

A resin coating film formed by applying resin coating on a bonded rare earth magnet can block contact of the air and moisture with magnet powder to some extent. Therefore, formation of a resin coating film improves oxidation resistance of a bonded rare earth magnet. However, the resin coating film gets more expansive or more decomposable as the temperature rises. Therefore, with an increase in the temperature of an environment in which a bonded rare earth magnet is used, the resin coating film has a higher oxygen transmission rate and a lower oxygen shielding effect, so oxidation proceeds and magnetic properties of the bonded rare earth magnet tends to deteriorate. In addition, mechanical strength is not sufficient. Namely, formation of a resin coating film on a bonded rare earth magnet alone is unable to provide sufficient oxidation resistance, depending on intended use.

A metallic coating film has a higher effect of blocking contact between oxygen and magnet powder than that of a resin coating film. Therefore, the bonded rare earth magnet of PTL 1 having a metallic coating film on a surface is improved in oxidation resistance. However, a resin coating film, an amorphous carbon film, and a metallic coating film are more permeable to oxygen in this order, and an amorphous carbon film does not have an oxygen blocking effect as high as a metallic coating film. That is to say, if an amorphous carbon film is further formed on a metallic coating film like in PTL 1, abrasion resistance, which is a week point of a metallic coating film, is improved but an effect of improving oxidation resistance cannot be expected. In other words, if only a good metallic coating film is formed on a surface of a bonded rare earth magnet, a sufficient oxidation resistance can be obtained, and therefore formation of an amorphous carbon film is not necessary.

However, since bonded rare earth magnets have relatively many pores, if a metallic coating film is formed on a surface of a bonded rare earth magnet by plating, an aqueous solution for plating enters into pores and the bonded rare earth magnet tends to corrode from an inside thereof. Besides, in a case of electrolytic plating, it is necessary to make a bonded rare earth magnet into an electrical conductor beforehand, production steps become complicated. Furthermore, if electrolytic plating is applied to a bonded rare earth magnet after assembled to a metallic base material, because the metallic base material is more easily plated than the bonded rare earth magnet, a metallic coating film is not sufficiently formed on a surface of the bonded rare earth magnet. On the other hand, as another method for forming a metallic coating film, there is a physical vapor deposition (PVD) method such as ion plating. However, a surface of a bonded rare earth magnet generally has a complicated shape such as concavities and convexities. Since in the PVD method metal atoms or particles deposit vertically on a surface to be coated, it is difficult to form uniform metallic coating films on uneven surfaces of bonded rare earth magnets. Even if a metallic coating film is formed on a surface of a bonded rare earth magnet, if the metallic coating film is not uniform, oxidation proceeds from insufficiently coated portions in use at high temperatures, so magnetic properties and oxidation resistance deteriorate. On the other hand, it is not industrially useful to form a metallic coating film by a chemical vapor deposition (CVD) method, because the CVD method uses a gas containing a very expensive organic metallic compound as a raw material gas. That is to say, if a good metallic coating film is formed on a bonded rare earth magnet, the bonded rare earth magnet can obtain an ideal oxidation resistance, but this is not industrially usable.

PTL 2 discloses that an amorphous carbon film can be formed directly on a surface of a sintered rare earth magnet. The present inventors formed amorphous carbon films directly on bonded rare earth magnets, but oxidation resistance was not sufficiently improved.

The present invention has been made in consideration of the above problems. It is an object of the present invention to provide a bonded rare earth magnet exhibiting excellent magnetic properties for a long time by improving oxidation resistance of the magnet at high temperatures.

### Means for Solving the Problems

Even though an amorphous carbon film was formed directly on a surface of a bonded rare earth magnet, as mentioned above, an improvement in oxidation resistance was small. Under these circumstances, the present inventors have newly found that the reason why it is difficult to improve oxidation resistance of a bonded rare earth magnet by forming an amorphous carbon film serving as an effective protective film on a surface of the bonded rare earth magnet is that a surface state of the bonded rare earth magnet affects the difficulty. The inventors have focused attention on the fact that in a conventional bonded rare earth magnet produced by a common method such as compression molding, both magnet powder and a resin are exposed on a surface thereof. As a result of earnest study of oxidation resistance of bonded rare earth magnets each having an amorphous carbon film relative to surface states of the bonded rare earth magnets, the present inventors have assumed that when an amorphous carbon film is formed directly on a surface of a conventional bonded rare earth magnet by a common vapor deposition method, some portions of surface of magnet powder are not covered with the amorphous carbon film and oxidation proceeds from these portions. Therefore, the present inventors have conceived that exposure of magnet powder on a surface of a bonded rare earth magnet before an amorphous carbon film is formed thereon is prevented by burying the magnet powder in a resin binding the magnet powder.

Namely, a bonded rare earth magnet of the present invention has a magnet body comprising magnet powder containing a rare earth element and a resin part binding the magnet powder and having a structure in which the magnet powder is embedded in the resin part; and an amorphous carbon film formed directly on a surface of the magnet body, the resin part comprising a binder resin part binding the magnet powder and a resin layer serving as a surface layer of the magnet body and covering the magnet powder.

### Advantageous Effects of Invention

In a conventional bonded magnet containing magnet powder at a high ratio, both magnet powder and a resin tend to be exposed on a surface thereof. In the bonded rare earth magnet of the present invention, because of having a resin layer as a surface layer of a magnet body, magnet powder is buried in the resin part in the surface layer of the magnet body. That is to say, in the bonded rare earth magnet of the present invention, an outermost layer of the magnet body is mostly constituted by resin, and an amorphous carbon film is directly formed on the outermost layer. Therefore, a uniform amorphous carbon film is easily formed.

By the way, a resin constituting the resin layer is soft and is widely different in hardness from an amorphous carbon film (about 800 to 3000 Hv). Generally, hard materials which are difficult to be deformed have small linear thermal expansion coefficients, while soft materials which are easy to be deformed have large linear thermal expansion coefficients. Therefore, it is expected that a big difference exists in linear thermal expansion coefficient or deformability between the amorphous carbon film and the resin layer. Therefore, it is assumed that even if an amorphous carbon film is formed on a resin layer, the amorphous carbon film cracks or is peeled off due to a difference in linear thermal expansion coefficient at high temperatures or a difference in deformability at high temperatures, so oxidation resistance at high temperatures decreases greatly. In the bonded rare earth magnet of the present invention, an amorphous carbon film is formed directly on a surface of a magnet body, that is, a surface of a resin layer, which is mostly constituted by resin. However, even if a hard amorphous carbon film is formed on a soft resin layer, in contrast to common knowledge, the amorphous carbon film is attached firmly to a surface of the magnet body without cracking or peeling off, and the amorphous carbon film fully serves as a protective film for providing oxidation resistance. The mechanism of this unexpected effect is not clear, the following assumption can be formulated from the result.

In the magnet body, owing to coexistence of magnet powder and resin, a binder resin part is restrained by magnet powder. In the restrained state, physical properties of magnet powder and those of resin are averaged. For example, the linear thermal expansion coefficient of the magnet body is a value between the linear thermal expansion coefficient of the resin (about 8×10⁻⁵/K) and the linear thermal expansion coefficient of the magnet powder (about 3×10⁻⁶/K). When magnet powder exists at a high density, a linear thermal expansion coefficient of portions where a binder resin part is restrained by magnet powder is a value closer to the linear thermal expansion coefficient of magnet powder. Physical properties of the portions where the binder resin part is restrained by the magnet powder affect those of a resin layer which contains little magnet powder. That is to say, the physical properties of the resin layer also get closer to those of the magnet powder, and a difference between the linear thermal expansion coefficient of the resin layer and that of the amorphous carbon film gets small. It is assumed that, as a result, cracking or peeling off of the amorphous carbon film at high temperatures is less likely to occur and the bonded rare earth magnet of the present invention is improved in oxidation resistance. Otherwise, it is assumed that since deformability of the resin layer at high temperatures gets closer to that of the amorphous carbon film due to a similar reason to linear thermal expansion coefficient, cracking or peeling off of the amorphous carbon film at high temperatures is less likely to occur. As a result, the bonded rare earth magnet of the present invention exhibits excellent oxidation resistance at high temperatures.

### BRIEF DESCRIPTION OF DRAWINGS

FIG. 1 are cross sectional views in which (1-1) schematically shows the vicinity of a surface of a magnet body before a resin coating film is formed thereon, (1-2) schematically shows the vicinity of a surface of a magnet body having a resin coating film as a resin layer, and (1-3) schematically shows the vicinity of a surface of the bonded rare earth magnet of the present invention comprising a magnet body and an amorphous carbon film formed on the magnet body.

FIG. 2 are cross sectional views in which (2-1) schematically shows the vicinity of a surface of a magnet body having a skin layer as a resin layer and (2-2) schematically shows the vicinity of a surface of the bonded rare earth magnet of the present invention comprising a magnet body and an amorphous carbon film formed on the magnet body.

FIG. 3 is a cross sectional view schematically showing an example of the bonded rare earth magnet of the present invention.

FIG. 4 is a cross sectional view schematically showing a specimen (a mock-up motor) used for a durability test.

FIG. 5 is a graph showing oxidation resistance of bonded rare earth magnets of an example and comparative examples.

### REFERENCE SIGNS LIST

10, 20, 30: magnet bodies
11, 21, 31: magnet powder (magnet particles)
   31′: fine powder
12, 22, 32: resin parts
13: a resin layer (a resin coating film)
14: a binder resin part
23, 33: skin layers
91, 92, 93: amorphous carbon films

### MODES FOR CARRYING OUT THE INVENTION

Hereinafter, best modes for carrying out the bonded rare earth magnet of the present invention (hereinafter abbreviated as “the bonded magnet of the present invention”) will be discussed. The bonded magnet of the present invention has a magnet body and an amorphous carbon film. The magnet body comprises magnet powder and a resin part.

The magnet powder contains a rare earth element. Common magnet powder used for bonded rare earth magnets can be used as the magnet powder. Examples of the magnet powder include rare earth magnet powder having known alloy composition such as a rare earth element-iron-nitrogen based magnet powder (e.g., an Sm—Fe—N based alloy powder), a rare earth element-iron-boron based magnet powder (e.g., an Nd—Fe—B based alloy powder), and a rare earth element-cobalt based magnet powder (e.g., an Sm—Co based alloy powder exemplified by such anisotropic Sm—Co based powder as anisotropic Sm₂Co₁₇ or SmCo₅ based magnet powder). Furthermore, magnet powder having such composition can be nanocomposite rare earth magnet powder, in which a hard magnetic phase and a soft magnetic phase coexist in a nanoscale structure. It is possible to employ one kind or a mixture of two or more kinds of these powders. Among these rare earth magnet powders, anisotropic magnet powder is employed when high magnetic properties are required, while isotropic magnet powder is employed when ease of magnetization is desired. It is possible to use either one or a mixture of both of anisotropic magnet powder and isotropic magnet powder. That is to say, magnet powder can include magnet powders having different kinds of composition or both anisotropic magnet powder and isotropic magnet powder, let alone one kind of magnet powder.

The kind of rare earth elements is not particularly limited, but it is preferable to employ at least one rare earth element except yttrium (Y) selected from the group consisting of lanthanum (La), cerium (Ce), praseodymium (Pr), neodymium (Nd), samarium (Sm), gadolinium (Gd), terbium (Tb), dysprosium (Dy), holmium (Ho), erbium (Er), thulium (Tm), and lutetium (Lu). It is especially preferable to employ Nd, Sm, Pr, Dy or Tb.

Moreover, the magnet powder can include two or more kinds of powder having different average particle diameters. That is to say, the magnet powder can include fine powder having a small average particle diameter. The fine powder can be not only the abovementioned various kinds of alloy powder but also ferrite powder or nanocomposite rare earth magnet powder. The fine powder can also be nonmagnetic powder comprising metal or metal oxide such as zinc, zinc oxide, silicon oxide, and aluminum oxide. In order to obtain high magnetic properties, it is preferable that the magnet powder includes coarse magnet powder and fine magnet powder having different average particle diameters. Concrete examples of a preferred combination of coarse magnet powder and fine magnet powder include a combination of Nd—Fe—B based alloy powder as coarse magnet powder and Sm—Co based alloy powder and/or Sm—Fe—N based alloy powder as fine magnet powder, a combination of Sm—Co based alloy powder as coarse magnet powder and Sm—Fe—N based alloy powder as fine magnet powder, and a combination of Nd—Fe—B based alloy powders as both coarse magnet powder and fine magnet powder. In order to improve heat resistance of the bonded magnet of the present invention, it is especially preferable to employ Sm—Co based alloy powder as fine magnet powder. If the fine powder is Sm—Co based alloy powder, the entire magnet powder has a higher Curie temperature and an improved coercive force. As a result, the bonded magnet of the present invention is excellent in both heat resistance and oxidation resistance.

It is preferable that coarse powder such as coarse magnet powder has an average particle diameter of about 50 to 150 μm, and more preferably 80 to 130 μm. On the other hand, it is preferable that fine powder has an average particle diameter of about not more than 20 and more preferably 1 to 10 μm. It should be noted that the average particle diameter of magnet powder mentioned in this description is defined as a volume median diameter (VMD) measured by laser diffraction.

That is to say, the bonded magnet of the present invention can employ any magnet powder comprising a mixture of a plurality of kinds of powders, in spite of alloy composition of magnet powder, whether magnet powder is anisotropic or isotropic, or average particle diameter of magnet powder, as long as at least a rare earth element is contained.

The resin part may comprise either a thermoplastic resin or a thermosetting resin. Examples of thermoplastic resin include nylon 66, nylon 12, polyphenylene sulfide resin, polyamide, polyimide, and polyethylene terephthalate, and it is possible to employ one kind or a mixture of two or more kinds of these resins. On the other hand, examples of thermosetting resin include epoxy resin, phenol resin, polyimide resin, polyamideimide resin, and melamine resin, and it is possible to employ only one kind or a mixture of two or more kinds of these resins.

The shape of the magnet body is not particularly limited and can be any shape which is suitable for an intended purpose of the bonded magnet of the present invention. For example, when the bonded magnet of the present invention is used for a motor, the magnet body can have a cylindrical shape. An additive such as an antioxidant can be arbitrarily added in accordance with use conditions.

Preferably the magnet body contains not less than 50 volume of magnet powder when the entire magnet body is defined as 100 volume %. When the magnet body contains not less than 50 volume % of magnet powder, a resultant bonded magnet can obtain sufficient magnetic properties. When the magnet body contains less than 50 volume % of magnet powder, even if magnet powder and resin coexist, it is difficult for a binder resin part to be restrained by magnet powder. As a result, physical properties, such as linear thermal expansion coefficient, of a surface of the magnet body (i.e., a surface of a resin layer) become equal to those of the resin, and an amorphous carbon film is not attached sufficiently firmly to this surface. Accordingly, a resultant bonded magnet does not exhibit excellent oxidation resistance at high temperatures. It is preferable that the magnet body contains not less than 80 volume % of magnet powder and more preferably not less than 85 volume % of magnet powder when the entire magnet body is defined as 100 volume %. Upon containing magnet powder at a high density, not only high magnetic properties are obtained but also an amorphous carbon film is attached sufficiently firmly to a surface of the magnet body. Namely, a bonded rare earth magnet exhibiting both high magnetic properties and excellent oxidation resistance can be obtained.

In the bonded magnet of the present invention, the magnet powder is buried in a resin part. It is desirable that all magnet powder is buried in the resin part, but it is only necessary that the area of magnet powder exposed on a surface is smaller than that of a conventional bonded magnet. Preferably the resin part has one of the following two structures. (1) The resin part comprises a binder resin part binding magnet powder, and a resin layer serving as a surface layer of the magnet body and covering the magnet powder. (2) The binder resin part and the resin layer are formed of the same resin material, and at the same time are formed of a binder resin continuously and integrally with each other. Thereinafter, (1) and (2) will be discussed respectively.

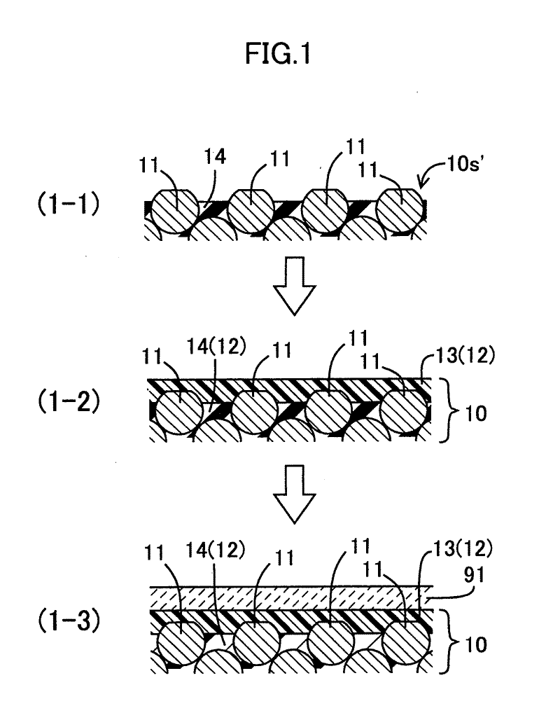

(1) For example, a high density formed body containing magnet powder at a high volume ratio is sometimes produced by compression molding in order to obtain high magnetic properties. Generally, such compression molding is carried out at a high specific pressure of about 9 ton/cm². Since a formed body thus obtained contains a relatively small amount of resin, the amount of resin seeped onto a surface of a formed body upon compression is not sufficient and a formed body having a surface on which magnet powder is exposed tends to be produced. Moreover, when an annular formed body is produced by “heat molding in a magnetic field” mentioned later, because a magnetic circuit forming part constituted by pure iron is easily deformable by molding pressure, specific pressure in compression molding need to be suppressed to not more than 4 ton/cm². Under such a low specific pressure, it becomes more difficult for a resin to be seeped onto a surface of a formed body and a formed body having a surface on which magnet powder is exposed tends to be produced. FIG. 1 (1-1) is a cross sectional view schematically showing the vicinity of a surface of a formed body after removed from a die. The formed body comprises magnet powder 11 constituted by a plurality of magnet particles, and a binder resin part 14 binding the magnet powder 11. The amount of resin seeped out is not sufficient and the magnet powder 11 is exposed on a surface 10s′ of a formed body and, in some cases, the magnet powder 11 projects from the surface 10s′. Upon providing the magnet body 10 with a resin layer 13 on the surface 10s′ of a formed body as shown in FIG. 1 (1-2), the magnet powder 11 is covered with a resin layer 13. That is to say, in the magnet body 10, the magnet powder 11 is buried in a resin part 12 which comprises the binder resin part 14 and the resin layer 13. Then, as shown in FIG. 1 (1-3), the bonded magnet of the present invention can be obtained by forming an amorphous carbon film 91 on the resin layer 13.

In this case, the resin layer may be formed of the same resin as the binder resin part constituting the magnet body or a different kind of resin from the binder resin part. The resin layer can be only one kind or a mixture of two or more kinds of the aforementioned resins which are suitable as binder resins. The resin layer only needs to have a sufficient film thickness to cover the magnet powder, and preferably has a thickness of not more than 50 μm or 20 to 50 μm and more preferably 20 to 30 μm. When the resin layer has a thickness over 50 μm, magnet powder's effect of restraining a resin part hardly influences a surface of the resin layer, physical properties in the vicinity of a surface of the resin layer becomes on the same level as those of the resin and a bigger difference exists between the linear thermal expansion coefficient of the resin layer and that of the amorphous carbon film. Therefore, adhesion deteriorates between the surface of the resin layer and the amorphous carbon film, and the amorphous carbon film tends to crack or be peeled off, which causes a decrease in oxidation resistance of the bonded magnet of the present invention. Besides, since the thickness of a resin layer which can be formed in a single step has a limit, formation of a resin layer having a thickness over 50 μm lowers productivity. On the other hand, a resin layer having a thickness of less than 20 μm is not preferable because such a layer is difficult to be formed and tends to be non-uniform in thickness, and portions where a resin layer is not sufficiently formed are liable to be generated. It should be noted that the thickness of the resin layer is defined as an arithmetic mean value of a shortest distance from an outermost surface of the magnet body to a surface of magnet particles.

The bonded magnet of the present invention having the resin part of the above structure (1) is produced by a production method comprising a preparation step of preparing a mixture comprising magnet powder and a resin, a main forming step of obtaining, from the mixture, a formed body comprising magnet powder and a binder resin part binding the magnet powder, a coating film forming step of forming a resin coating film on a surface of the formed body, and an amorphous carbon film forming step of forming an amorphous carbon film on a surface of the resin coating film.

In the preparation step, it is only necessary to weigh and mix magnet powder and a resin at a predetermined composition ratio to prepare a mixture. The magnet powder and the resin used have been mentioned before. The prepared mixture is shaped in the main forming step, thereby obtaining a formed body comprising magnet powder and a binder resin part binding the magnet powder. The forming method employed in the main forming step is not particularly limited, but it is preferable to employ compression molding which comprises softening or melting a resin while applying pressure on the mixture in a forming die and then solidifying the resin, thereby obtaining a formed body. Compression molding can easily produce a formed body which contains not less than 80 volume % of magnet powder when the entire formed body is defined as 100 volume %, but magnet powder tends to be exposed on a surface of the formed body. Therefore, in the next coating film forming step, a resin coating film is formed on a surface of the formed body. It should be noted that the formed body can be produced not only by compression molding but also by extrusion molding, calendering, injection molding or the like.

The coating film forming step is a step of forming a resin coating film, that is to say, a resin layer on a surface of the formed body. The method of forming a resin coating film is not particularly limited. The coating method and hardening conditions can be selected in accordance with the kind of resin coating material to be used.

The amorphous carbon film forming step is a step of forming an amorphous carbon film on a surface of the resin coating film. This amorphous carbon film forming step will be discussed later in detail.

In addition, an orientation step can be carried out for orienting magnet powder by applying an orienting magnetic field to the mixture after the preparation step with the resin softened or melted. When the magnet powder includes anisotropic magnet powder, the anisotropic magnet powder can be oriented in a particular direction by applying a magnetic field in the orientation step and then the mixture can be subjected to main forming with the magnetic field kept applied. It should be noted that a production method including an orientation step is generally called “heat molding in a magnetic field”. In addition, the production process may include a preforming step of obtaining a preform by forming the mixture after the preparation step. A formed body with a high dimensional accuracy can be obtained by forming the mixture into a preform having a predetermined shape beforehand, and then subjecting the preform to heat molding in a magnetic field in a forming die placed in a magnetic field.

It should be noted that when used in assembly with another member, the bonded magnet of the present invention can be assembled in subsequent steps after the main forming step. That is to say, it is possible to form a resin coating film and an amorphous carbon film after the formed body obtained in the main forming step is assembled to another member, and it is also possible to form an amorphous carbon film after a formed body having a resin coating film thereon (a magnet body) is assembled to another member. It goes without saying that it is possible to assemble to another member a bonded magnet obtained after an amorphous carbon film forming step is carried out, that is to say, a formed body on which both a resin coating film and an amorphous carbon film have been formed. (2) Moreover, the resin part may be formed of a continuously extending binder resin. That is to say, in the structure (1), the binder resin part and the resin layer are formed of the same resin and are continuous and integral with each other. Such a structure is obtained by forming a skin layer, which is a resin layer, on a surface of the magnet body when the magnet body is shaped.

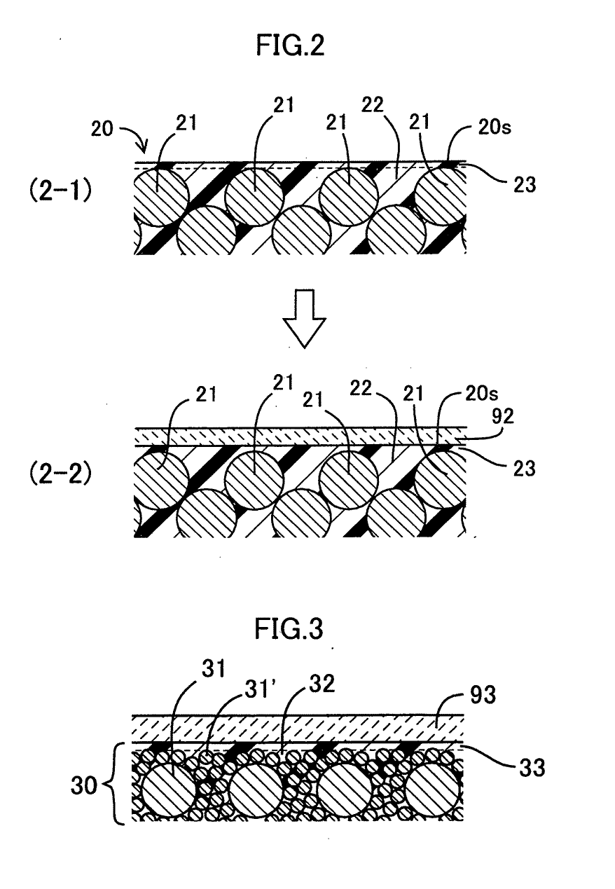

FIG. 2 (2-1) is a cross sectional view schematically showing the vicinity of a surface of the magnet body (a formed body) 20 having a skin layer, for example, when a formed body containing magnet powder at a low volume ratio is produced by compression molding. The magnet body 20 comprises magnet powder 21 constituted by a plurality of magnet particles and a resin part 22 binding the magnet powder 21. The resin part 22 is formed of the aforementioned resin material (the binder resin). A surface layer of the resin part 22 is a skin layer 23 which does not contain the magnet powder 21 and is formed of the same binder resin. Covering the magnet powder 21 with the skin layer 23 at a surface 20s of the magnet body 20 produces the magnet body 20 in which the magnet powder 21 is buried in the resin part 22. Then, as shown in FIG. 2 (2-2), the bonded magnet of the present invention can be obtained by forming an amorphous carbon film 92 on the skin layer 23. The skin layer 23 is obtained by having a binder resin seeped onto a surface of a forming die (i.e., a surface of a formed body) in a forming process such as compression molding, and thereby the magnet powder 21 is buried in the resin part 22. As a result, after a formed body is removed from the forming die, the magnet powder 21 is scarcely exposed on a surface of the magnet body 20. It should be noted that even if the magnet powder 21 is exposed to a surface to some degree, oxidation resistance improves.

Preferably the skin layer has a thickness of not more than 10 μm, and more preferably not more than 5 μm or 3 μm. In a viewpoint of productivity, it is difficult for the skin layer to have a thickness over 10 μm. When there is a fear that the magnet powder may not be buried in the resin part, a resin layer can additionally be formed on the skin layer. It should be noted that the thickness of the skin layer is defined as an arithmetic mean value of a shortest distance from an outermost surface of the magnet body to a surface of the magnet particles when the magnet body is cut perpendicularly to a surface.

The bonded magnet of the present invention having the resin part of the aforementioned structure (2) is produced by a production method comprising a preparation step of preparing a mixture comprising magnet powder and a resin, a main forming step of obtaining, from the mixture, a formed body comprising magnet powder and a resin part binding the magnet powder and having a skin layer constituted by a resin as a surface layer thereof, and an amorphous carbon film forming step of forming an amorphous carbon film on a surface of the skin layer. If necessary, the production method can include the above-mentioned orientation step and/or the abovementioned preforming step. The skin layer is formed in the main forming step. Therefore, the above-mentioned coating film forming step of forming a resin coating film is not essential. In other words, if a skin layer is formed in the main forming step, the coating film forming step can be omitted. Hereinafter, the main forming step will be discussed.

The main forming step is a step of obtaining, from the mixture, a formed body comprising magnet powder and a resin part binding the magnet powder and having a skin layer constituted by a resin as a surface layer thereof. The skin layer can be formed at a desired thickness by controlling a mixing ratio of magnet powder and a resin in the preparation step, and heating temperature and forming pressure in the main forming step. Especially when a mixture is prepared such that the volume ratio of the binder resin in the entire magnet body is larger than usual, a resin is more easily seeped onto a surface of a forming die and a skin layer is more easily formed in the main forming step. It should be noted that the skin layer is similarly formed even when the abovementioned magnet powder including fine powder is employed.

Since the skin layer is thinner than the resin layer of the bonded magnet having the structure (1), adherence of an amorphous carbon film to a surface of the magnet body in a high temperature region improves further. Moreover, since the skin layer is formed extremely thinly, a decrease in magnetic force due to the cover of the magnet powder with the resin layer is suppressed. For example, output of a motor is greatly changed by an air gap between a stator and a rotor. If the bonded magnet having the structure (2) is used in a motor, an air gap is substantially small because the skin layer, which is nonmagnetic, is extremely thin. As a result, output power of the motor is increased.

The reason why a difference in adherence of an amorphous carbon film at high temperatures exists between the resin layer of the structure (1) and the resin layer (i.e., the skin layer) of the structure (2) is generally considered as follows. Physical properties of a portion where the binder resin part is restrained by the magnet powder affect those of the resin layer, as mentioned before. Owing to this effect, a difference in linear thermal expansion coefficient or deformability becomes small between the resin layer and the amorphous carbon film and cracking or peeling off of the amorphous carbon film at high temperatures is less likely to occur. This effect is more pronounced as the resin layer has a smaller thickness. Formed mainly as a resin coating film, the resin layer of the structure (1) has a relatively large thickness of not less than 20 μm. In contrast, the skin layer has a thickness of about several and a surface of the skin layer is more affected by a portion where the binder resin part is restrained by the magnet powder (corresponding to a portion below the broken line in FIG. 2 (2-1)). Moreover, since the skin layer is formed of the same resin material as the binder resin part and is continuous and integral with each other, that effect is much more profound. That is to say, physical properties of the skin layer get very close to those of the magnet powder and a difference in linear thermal expansion coefficient between the skin layer and the amorphous carbon film gets even smaller, and adherence of the amorphous carbon film to a surface of the skin layer improves.

As mentioned before, in the bonded magnet of the present invention, magnet powder can include two or more kinds of powders having different particle diameters such as a combination of coarse magnet powder and fine powder. Since the ratio of the magnet powder restraining the binder resin part is increased by containing fine powder, the resin layer and the amorphous carbon film have a much smaller difference in linear thermal expansion coefficient or deformability at high temperatures, and the amorphous carbon film at high temperatures is more suppressed from being peeled off or cracking. On the other hand, when the binder resin part and the resin layer (the skin layer) are continuous with each other as in the structure (2), fine powder can be filled at a high density in a portion just below the skin layer. A state in which fine powder is filled at a high density in a portion just below the skin layer will be discussed with reference to FIG. 3.

FIG. 3 is a cross sectional view schematically showing the vicinity of a surface of the bonded magnet of the present invention which employs magnet powder including coarse magnet powder and fine magnet powder. A magnet body 30 comprises coarse magnet powder 31, fine magnet powder 31′ and a resin part 32. The magnet powders 31 and 31′ are held by the resin part 32. A surface layer of the resin part 32 is a skin layer 33, and a magnet body 30, in which the magnet powders 31 and 31′ are buried in the resin part 32, is produced by covering the magnet powders 31 and 31′ with the skin layer 33. In this case, a layer mainly comprising fine magnet powder 31′ is formed just below the skin layer 33. This layer is formed by seeping of the fine powder 31′ s simultaneously with seeping of the binder resin from gaps between particles of the coarse magnet powder 31 in compression molding, locating the fine powder 31′ on a surface of the coarse magnet powder 31 beforehand, or the like. Owing to formation of a layer mainly comprising the fine magnet powder 31′ just below the skin layer 33, a surface portion of the magnet body 30 contains magnet powder at a higher density than a surface portion of the magnet body 20 of FIG. 2 (2-2). Since physical properties of the layer mainly comprising the fine magnet powder 31′ get even closer to those of the magnet powder, physical properties of the skin layer 33 also get even closer to those of the amorphous carbon film. It is assumed that as a result of this, the amorphous carbon film at high temperatures is much more suppressed from cracking or being peeled off and the bonded magnet of the present invention is improved in oxidation resistance.

In the bonded magnet of the present invention, the amorphous carbon film is formed directly on a surface of the magnet body. It should be noted that the amorphous carbon film only has to be formed at least on a surface of the magnet body which requires protection.

The amorphous carbon (diamond-like carbon: DLC) film is a coating film comprising a carbon material which contains carbon as a main component and has an amorphous structure.

Surface hardness and oxygen barrier properties of a DLC film vary with composition. Oxygen barrier properties are affected by a hydrogen content in the DLC film and as the DLC film has a lower hydrogen content, less oxygen passes through the DLC film. Therefore, upon controlling the hydrogen content preferably to not more than 40 at and more preferably to not more than 20 at % when the entire DLC film is defined as 100 at %, the oxygen transmission rate is decreased and the bonded magnet of the present invention is improved in oxidation resistance. On the other hand, as the DLC film has a higher hydrogen content, the DLC film tends to have a lower surface hardness. It should be noted that the DLC film can contain silicon, oxygen, titanium, aluminum, chromium and so on in addition to hydrogen.

The DLC film is formed in the above amorphous carbon film forming step. The DLC film can be formed by a chemical vapor deposition (CVD) method such as plasma CVD, or a general vacuum deposition method such as sputtering, ion plating and other physical vapor deposition (PVD) methods. The CVD method is especially desirable. The CVD method can form a uniform DLC film even when the magnet body has an uneven surface or a complicated shape.

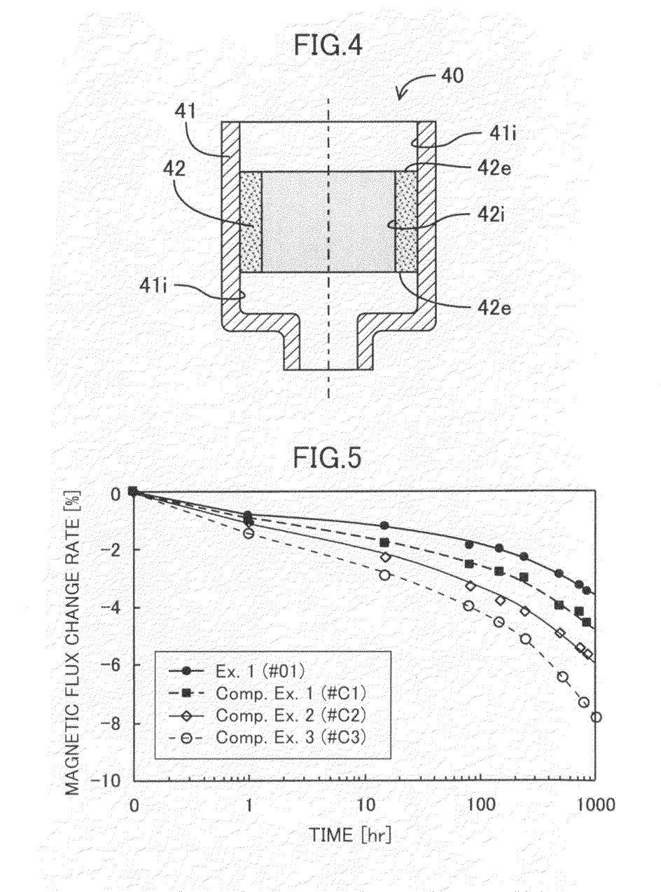

When the bonded magnet or the bonded magnet assembled to another member has a complicated shape, plasma CVD is suitable for forming a uniform DLC film on a surface of the bonded magnet. This is because in plasma CVD, a bias source can be arranged in accordance with the shape of an object to be coated by a DLC film. For example, an object to be coated by a DLC film has the shape of a hollow cylinder with a bottom shown in Example 1 (FIG. 4) mentioned later, a bias source is produced in accordance with an outer shape of the object and in a film forming process, an ionized gas raw material is accelerated by applying a bias electric field from an outside to an inside of the object. Then, upon inducing the gas raw material to the inside of the object, a DLC film can be formed in a manner to be attached tightly to the entire inner peripheral surface, even when the inner peripheral surface has a complicated shape. For example, even if the inner peripheral surface has a plane which faces the bottom, the DLC film can be formed uniformly on the entire inner peripheral surface.

Raw material gas used for the CVD method is a hydrocarbon-based compound gas expressed as a chemical formula CₓH_{y} where x is at least one and y is at least two. For example, a DLC film containing hydrogen can be obtained by using methane, acetylene, toluene, adamantine and so on as a raw material.

The thickness of the DLC film is not particularly limited, but in view of industrial productivity, it is preferable that the DLC film has a thickness in a range of from 50 nm to 50 μm. As the DLC film has a greater thickness, oxidation resistance improves. It should be noted that the thickness of the DLC film can be controlled to a desired thickness by controlling film forming time.

The bonded magnet of the present invention has an amorphous carbon film formed directly on a surface of the magnet body (i.e., a surface of a resin layer), and may have an intermediate layer located between the surface of the magnet body and the amorphous carbon film and comprising a chemical compound having an M-C bond, an M-N—C bond, or an M-O—C bond, where M, C and N respectively represent atoms and M is metal or silicon, C is carbon, N is nitrogen and O is oxygen. Owing to the existence of the intermediate layer between the resin layer and the amorphous carbon film, internal stress is relieved and adherence between the resin layer and the amorphous carbon film further improves. Preferably the intermediate layer contains silicon, titanium, aluminum or the like as M. Concrete examples of the intermediate layer include a SiC film, a SiCN film, a SiCNO film, a TiC film, a TiCN film, an AlC film, an AlCN film, and an AlCNO film. It is especially preferable to employ a SiC film or a SiCN film. Preferably these intermediate layers are formed by a general vacuum deposition method similarly to the DLC film. In view of adherence, it is preferable that the intermediate layer has a film thickness of 10 nm to 1 μm. When the intermediate layer is formed by vacuum deposition, the thickness can be controlled to a desired thickness by controlling film forming time.

Preferably the bonded magnet of the present invention discussed heretofore exhibits a magnetic flux change rate of not more than 5% and more preferably not more than 4%. It should be noted that the “magnetic flux change rate” is defined as a value calculated from the amounts of magnetic flux before and after a durability test in which a magnet is exposed in the air at 150 deg. C. for 1,000 hours. The magnetic flux change rate can be calculated by (φₜ−φ₀)×100/φ₀ [%], wherein φ₀ is the amount of magnetic flux of a magnet before a durability test and φₜis the amount of magnetic flux of the magnet after the test.

While the modes for carrying out the bonded rare earth magnet of the present invention and a method for producing the same have been discussed above, the present invention is not limited to the above modes. The present invention can be carried out in various modes to which modifications and improvements are made by those skilled in the art without departing from the gist of the present invention.

### EXAMPLES

Hereinafter, the present invention will be specifically discussed by means of examples of the bonded rare earth magnet of the present invention

### Example 1

### [Production of Formed Bodies]

A compound material was prepared as magnet powder by mixing d-HDDR treated anisotropic NdFeB based magnet powder (composition: Fe-12.5 at % Nd-6.4 at B-0.5 at % Dy-0.3 at % Ga-0.2 at % Nb) and anisotropic SmCo based magnet powder (composition: Co-19.6 at Fe-10.9 at % Sm-7.0 at Cu-2.5 at % Zr) (85 volume %) and heat resistant novolac-type epoxy resin powder (15 volume %). The prepared anisotropic NdFeB based magnet powder had an average particle diameter of 115 μm (coarse powder) and the prepared anisotropic SmCo based magnet powder had an average particle diameter of 12 μm (fine powder). The volume ratio of the coarse powder to the fine powder was 80:20. An addition of Dy to the anisotropic NdFeB based magnet powder improves coercive force and heat resistance. The abovementioned anisotropic SmCo based magnet powder has the same level of coercive force as the Dy-added anisotropic NdFeB based magnet powder, and high heat resistance owing to a high Curie temperature.

The abovementioned compound material was subjected to powder compacting in a mold, thereby obtaining a preform. Next the preform was placed in a mold in a heating device. Then, while the mold was heated to 135 deg. C. such that the epoxy resin powder would be softened or melted (i.e., be put in a low viscosity state), a magnetic field of 1.3 T was applied so as to orient the magnet powder. After the magnetic field started to be applied to the preform, a specific pressure of 3.3 ton/cm² was applied while keeping the magnetic field. After that, the epoxy resin was cured by holding the preform at 150 deg. C. for 30 minutes, thereby obtaining a hollow cylindrical formed body of 33 mm φ in outer diameter, 30 mm φ in inner diameter and 25 mm in height in which the magnet powder was connected together by the epoxy resin.

### [Preparation of a Specimen for a Durability Test (a Mock-up Motor)]

The obtained formed body was press fitted into a cylindrical portion of a motor casing formed of steel and having the approximate shape of a hollow cylinder with a bottom. Though the formed body was fixed to the casing by press fitting in this example, the formed body may be glued to the casing. Next, an epoxy resin coating material was applied on a surface (an inner circumferential surface and both end surfaces) of the formed body. The formed body after applied with the coating material was subjected to baking at 125 deg. C. for 40 minutes, thereby forming a resin coating film. A magnet body was thus obtained.

When the thickness of the resin coating film was measured, the film thickness was 20 μm. The measurement of the film thickness was conducted by cutting the cylindrical magnet body in half along its center axis and measuring a shortest distance from an outermost surface of the magnet body to a surface of the magnet particles in a cross section. Measurement was conducted at three portions, that is to say, an axial center portion and both axial end portions which are respectively at an axial distance of 8 mm from the center portion. At each of the center portion and both the end portions, a shortest distance from an outermost surface of the magnet body to a surface of respective magnet particles was measured at 10 points in an axial range of 1 mm, and an arithmetic mean value of them was calculated, and then an average value of the obtained arithmetic mean values at three portions was defined as film thickness. Moreover, the ratio of the magnet powder was 85 volume % when the magnet body was defined as 100 volume %, which was the same level as the volume ratio in the compound material.

Next, a DLC film was formed on an inside of the motor casing including an inner circumferential surface and both end surfaces of the magnet body. The DLC film was formed by employing methane (CH₄) as a raw material gas and using a known plasma CVD apparatus under a degree of vacuum in film forming (CH₄ gas pressure) of 0.2 Torr (26.7 Pa) at a film forming temperature (surface temperature of the magnet body) of 100 deg. C. Film forming for one hour produced a DLC film having a film thickness of 1.0 μm.

Then the magnet body having a DLC film was magnetized, thereby preparing a specimen for a durability test. FIG. 4 schematically shows a cross section of the durability test specimen. The durability test specimen 40 comprises a motor casing 41 having the approximate shape of a hollow cylinder with a bottom, and a magnet body 42 press fitted in a cylindrical portion of the motor casing 41. A resin coating film was formed on an inner circumferential surface 42i and both axial end surfaces 42e of the magnet body 42. A DLC film was also formed on an inner peripheral surface 41i of the motor casing 41, the inner circumferential surface 42i and both the axial end surfaces 42e of the magnet body 42 having the resin coating film thereon.

That is to say, a durability test specimen of Example 1 having a bonded rare earth magnet #01 provided with a resin coating film and a DLC film on a surface of a magnet body was obtained by the above procedure. In Example 1, it was confirmed that a DLC film was uniformly formed on the entire inside of the durability test specimen (and the motor casing).

### Comparative Example 1

A durability test specimen having a bonded rare earth magnet #C1 provided with a DLC film on a surface of a magnet body was produced by a similar procedure to that of Example 1, except that a resin coating film was not formed.

### Comparative Example 2

A durability test specimen having a bonded rare earth magnet #C2 provided with a resin coating film on a surface of a magnet body was produced by a similar procedure to that of Example 1, except that a DLC film was not formed.

### Comparative Example 3

A durability test specimen having a bonded rare earth magnet #C3 with an untreated surface was produced by a similar procedure to that of Example 1, except that neither a resin coating film nor a DLC film was formed.

### Evaluation

A durability test was carried out by exposing the respective durability test specimens in the air at 150 deg. C. for 1,000 hours. That is to say, oxidation resistance of the respective specimens were evaluated by measuring the amount of magnetic flux by a magnetic flux meter after placing the specimens in a dry oven at 150 deg. C., taking out the specimens after a predetermined time, and cooling the specimens to room temperature. Oxidation resistance was evaluated by a magnetic flux change rate, which can be calculated by (φₜ−φ₀)×100/φ₀ [%] wherein φ₀ is the amount of magnetic flux of each of the specimens before the durability test, and φₜ is the amount of magnetic flux of each of the specimens taken out after a predetermined time t. The results are shown in FIG. 5.

In #C3 having neither a resin layer nor a DLC film on a surface of the magnet body, the amount of magnetic flux after 1,000 hours decreased by about 8%. In the bonded rare earth magnet of #C3, the magnet powder (s) containing the rare earth elements were exposed to a surface, and the reason why magnetic properties were lowered is that oxidation proceeded from the surface. In #C1 and #C2 having either the resin coating film or the DLC film on a surface, the amount of magnetic flux had lower decrease rates and accordingly oxidation resistance was better than that of #C3. However, the magnetic flux change rate of #C1 and #C2 exceeded 5% and sufficient effects were not observed. #C2 having only the resin coating film did not keep a high oxidation resistance effect at a high temperature. Moreover, in #C1 in which a DLC film was formed directly on a surface of #C3, it was observed that some portions of exposed surfaces of the magnet powder were not completely covered with the DLC film. Moreover, in #C1, cracking or peeling off of the DLC film was observed and it is estimated that the oxygen shielding effect of the DLC film was not sufficient. In #C1 having both the resin coating layer and the DLC film, the decrease rate of the amount of magnetic flux was well below 5%. Since a DLC film was formed after the magnet powder exposed on a surface of the magnet body was covered with a resin coating film, the DLC film was uniformly formed on the entire surface and oxidation resistance at a high temperature improved greatly.

The surface states of the bonded rare earth magnets and magnetic flux change rates after the durability test of 1,000 hours are summarized in Table 1.

TABLE 1

| DURABILITY | | | | MAGNETIC |
|---|---|---|---|---|
| TEST | | SURFACE STATE | | FLUX CHANGE |
| SPECIMEN | | RESIN LAYER | DLC FILM | RATE [%] |
| Ex. 1 | #01 | PRESENT | PRESENT | −3.5 |
| | | (RESIN | | |
| | | COATING | | |
| | | FILM) | | |
| Comp. Ex. 1 | #C1 | ABSENT | PRESENT | −5.1 |
| Comp. Ex. 2 | #C2 | PRESENT | ABSENT | −5.7 |
| | | (RESIN | | |
| | | COATING | | |
| | | FILM) | | |
| Comp. Ex. 3 | #C3 | ABSENT | ABSENT | −7.9 |

1. A bonded rare earth magnet, having:
a magnet body comprising magnet powder containing a rare earth element and a resin part binding the magnet powder and having a structure in which the magnet powder is embedded in the resin part; and
an amorphous carbon film formed directly on a surface of the magnet body,
the resin part comprising:
a binder resin part binding the magnet powder; and
a resin layer serving as a surface layer of the magnet body and covering the magnet powder.

2. The bonded rare earth magnet according to claim 1, wherein the binder resin part and the resin layer are formed of the same resin material and are continuous and integral with each other.

3. The bonded rare earth magnet according to claim 1, wherein the magnet powder includes coarse magnet powder and fine magnet powder having different average particle diameters.

4. The bonded rare earth magnet according to claim 3, wherein the fine magnet powder is a rare earth element-cobalt based magnet powder.

5. The bonded rare earth magnet according to claim 4, wherein the coarse magnet powder is a neodymium-iron-boron (Nd—Fe—B) based magnet powder and the fine magnet powder is a samarium-cobalt (Sm—Co) based magnet powder.

6. The bonded rare earth magnet according to claim 1, wherein the amorphous carbon film contains carbon as a main component and not more than 40 atomic % of hydrogen when the entire amorphous carbon film is defined as 100 atomic %.

7. The bonded rare earth magnet according to claim 1, further having an intermediate layer located between the surface of the magnet body and the amorphous carbon film and comprising a compound having a bond expressed as M-C, M-N—C, or M-O—C, wherein M is metal or silicon, C is carbon, N is nitrogen and O is oxygen.

8. The bonded rare earth magnet according to claim 7, wherein the intermediate layer is an SiC film or an SiCN film.

9. The bonded rare earth magnet according to claim 6, further having an intermediate layer located between the surface of the magnet body and the amorphous carbon film and comprising a compound having a bond expressed as M-C, M-N—C, or M-O—C, wherein M is metal or silicon, C is carbon, N is nitrogen and O is oxygen.

10. The bonded rare earth magnet according to claim 9, wherein the intermediate layer is an SiC film or an SiCN film.
